(19) United States
(12) Patent Application Publication
(10) Pub. No.: US 2011/0030824 A1
(43) Pub. Date: Feb. 10, 2011

(54) THERMAL ENERGY MANAGEMENT FOR PRODUCTION INSTALLATIONS

(76) Inventor: Thomas Rauch, Koln (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/736,544

(22) PCT Filed: Apr. 15, 2009
(86) PCT No.: PCT/EP2009/054466

§ 371 Date: Oct. 15, 2010

(30) Foreign Application Priority Data
Apr. 22, 2008 (DE) 10 2008 001 308.0

(51) Int. Cl. E03B 1/00; G05D 23/00; F24H 9/00; B01D 35/027

(52) U.S. Cl. 137/605; 165/300; 165/47; 210/149

(57) ABSTRACT

Thermal energy management for production installations is provided. A storage tank for storing a fluid heated in relation to the ambient temperature has a heat-insulated wall and at least one discharge and one feed. The storage tank stores the amounts of heat occurring at various process stations in an installation, and, if required, delivers them again, with a high level of efficiency. The discharges and the feeds are arranged at different height levels of the storage tank and associated with the storage tank is a control device which passes a fluid flow at higher temperature through a discharge or feed at a higher height level and a fluid flow at a lower temperature through a discharge or feed at a lower height level. Alternatively the feeds and discharges can be displaceable in respect of height. In that case one feed and one discharge can be sufficient.

### TECHNICAL FIELD

The invention concerns thermal energy management for production installations and is directed in particular to a storage tank for storing a fluid heated in relation to the ambient temperature, the storage tank having a heat-insulated wall and at least one discharge and one feed.

### BACKGROUND ART

An apparatus of that kind is known for example from European patent application EP 0 048 235. That document proposes feeding the waste heat from a heat-consuming production installation to various heat collectors. The heat collectors contain water fillings at temperatures at different temperature levels. The fluid flows from the production installation can be fed to that heat collector, the temperature of which corresponds to the fluid temperature.

Alternatively the fluid flows from the production installation can be used for heating a fluid in the heat collectors by means of a heat exchanger.

Heat recovery of that kind provides for considerable energy savings, in comparison with installations in which heated fluid, for example heated industrial service water, is passed to a drain.

### DISCLOSURE OF INVENTION

The object of the invention is to provide, with a relatively low level of complication and expenditure, a storage tank which with a high level of efficiency stores the amounts of heat occurring at various process stations in an installation, and which if required delivers said amounts of heat again.

To attain that object, two different embodiments of a storage tank are proposed.

In a first storage tank for the storage of a fluid heated in relation to the ambient temperature, having a heat-insulated wall, a plurality of discharges and a plurality of feeds, the object according to the invention is attained in that the discharges and the feeds are arranged at different height levels of the storage tank and associated with the storage tank is a control device which passes a fluid flow at higher temperature through a discharge or feed at a higher height level and a fluid flow at a lower temperature through a discharge or feed at a lower height level.

In a storage tank for the storage of a fluid heated in relation to the ambient temperature, having a heat-insulated wall, at least one discharge and at least one feed, the object according to the invention is attained in that the discharge and the feed are displaceable to different height levels of the storage tank and associated with the storage tank is a control device which passes a fluid flow at higher temperature to the discharge or feed at a higher height level and a fluid flow at a lower temperature to the discharge or feed at a lower height level.

In other words, it is proposed that all of the heated waste water which occurs in complex production installations at different temperature levels is stored in a single central storage tank. This results in a temperature-layered filling of the storage tank. The temperature layering is maintained by virtue of the temperature-dependent density of a fluid.

As a rule the fluid used in a production installation is service water. Water is of the greatest density at 4° C. At higher temperatures the density progressively falls with temperature. Consequently, the coldest water involving the greatest density collects in the lower region in a storage tank whereas the hotter and less dense water is further upwardly.

Water can be taken from a storage tank according to the invention precisely at the temperature required at a given process station of a production installation. The control device can establish the height level of the discharge, from which the water is taken from the storage tank, in dependence on the location at which the water is consumed.

Equally fluid flowing to the storage tank can be fed thereinto at the height level at which the temperature of the fluid in the tank corresponds to the temperature of the feed flow of fluid. That prevents heat exchange in respect of the inflowing fluid, with the fluid which is in the tank. Thus, the temperature layering in the storage tank is not disturbed.

At least one temperature sensor should be associated with the control device, for measuring the temperature of the flowing fluid, wherein the control device, in dependence on the measured temperature, establishes the height level of the discharge or feed. In practice, temperature sensors can be arranged at various height levels of the storage tank, preferably in the proximity of the discharges or the discharge, in order to detect the actual temperature value at the different height levels of the tank. Depending on the respective filling of the tank, the temperature value prevailing at a given height may vary. The filling of the storage tank may also cool with the passage of time so that the layers at given temperature values are displaced upwardly.

For the medium which flows into the tank, a temperature sensor is sufficient, which causes the control device to feed the medium to the height level of the storage tank, at which the temperature of the feed flow of medium prevails.

Industrial service water can be fed directly to the tank. That involves water which is not of drinking water quality but which is used in various production procedures. Other fluids which are used in production procedures can deliver their thermal energy to the fluid in the storage tank by way of heat exchangers.

Thus, certain production installations frequently operate with hot steam to achieve the high temperatures required. Hot steam can be obtained from power stations with power/heat coupling. The condensate of the hot steam, which is results after energy delivery, must be recycled to the power station as this involves valuable contamination-free water which for cost reasons is to be recycled to the steam circuit of the power station. Consequently the condensate may not be fed to the service water in the storage tank and can deliver its energy to the fluid in the storage tank by way of a heat exchanger.

Likewise it is also possible to use at the process stations, heated fluids which may not be fed to the industrial service water. For example the fluids may contain contaminations which are detrimental to health. In this case also the thermal energy is fed to the service water in the storage tank, from the fluids at the process stations of the production installation, by way of heat exchangers.

Similarly, during the production procedure, fluids can be heated at the process stations of the production installation by means of heat exchangers, by hot fluid from the storage tank. In that case the hot fluids flow out of the storage tank from a discharge at a height level to the primary side of a heat exchanger and, after passing through the heat exchanger, at a lower temperature, flow to a feed into the storage tank, which is at a lower height level.

It will be appreciated that condensers in which the fluid flow fed to the storage tank is heated may also be used for the recovery of thermal energy from a flow of steam.

The discharges for taking the hotter fluid flow from the tank are preferably arranged in the upper region of the storage tank. The feed to which a fluid flow at a colder temperature level is usually fed is arranged in particular in the lower region of the storage tank. However, it is to be noted that, depending on the respective temperature level of the inflowing and outflowing fluid, both the feed and also the discharge can be arranged over the entire height of the storage tank.

In practice the storage tank is preferably of a volume of 1000 m³ or more. Such a volume of water permits flexible heat recovery in relation to large production installations such as for example paper manufacturing installations. Depending on the respective size of the installation however the storage tank can also be smaller (for example 500 m³) or very much larger (for example 4000 m³ and more).

A heat exchanger can be arranged in the interior of the tank. In that way for example thermal energy can be directly fed to the storage tank without fluid having to be taken therefrom and then passed thereto again. The heat exchanger can be arranged displaceably in respect of height. Alternatively a plurality of heat exchangers can be provided at different heightwise positions in the tank.

In practice, it is possible to arrange upstream of the feed to the storage tank a filter through which the feed flow of fluid passes. In particular, an ultrafiltration unit can be used as the filter. Ultrafiltration is a process in which even finer particles than in microfiltration are separated off. Microfiltration filters off particles measuring 0.5 to 0.1 μm from liquids, whereas ultrafiltration filters off particles measuring 0.1 to 0.01 μm. A powerful filter installation ensures that the fluid flowing back into the storage tank (in particular process water and other service water) flows into the storage tank in a cleaned, clear condition so that its purity and quality allows subsequent use in the various process stations.

The invention further concerns a production installation comprising a plurality of process stations which each use at least one fluid at a given temperature, wherein the production installation has a storage tank of the above-described kind. The storage tank can be used in the production procedure in the following fashions alternatively or at the same time:
1. A fluid is taken from the storage tank at a given height level by the control device in dependence on the temperature required by way of a discharge and fed to the process station;
2. The fluid flowing away from the process station after use is fed to a feed at a given height level by the control device at a given temperature; and
3. The fluid for the process station is heated by way of a heat exchanger supplied with hot fluid from the storage tank.

In particular the storage tank according to the invention is provided for use in a modern paper mill. It reduces and minimises the steam consumption. In a paper mill, different fluids at different temperatures occur at various process stations. The drying stations are supplied with steam, which involves the occurance of considerable working temperatures. In part, cooling water is used to dissipate the temperatures by way of cooling towers. Storing the heat from drying stations in a storage tank of the kind according to the invention can lead to considerable energy savings.

The service water at the various process stations, for example the process vats, can be put into intermediate storage in the storage tank at least during an interruption in manufacture in the paper mill so that the heat stored therein is not lost.

Water from the storage tank can be passed to the process stations again directly as process water or other service water. It can further be used to heat machines, factory shops and buildings. Finally it can also heat drinking water by way of heat exchangers.

### BRIEF DESCRIPTION OF DRAWINGS

Embodiments of the invention are described hereinafter with reference to the accompanying drawings.

FIG. 1 shows a view in cross-section of a first embodiment of a storage tank according to the invention, and

FIG. 2 shows a second embodiment of a storage tank according to the invention.

### EMBODIMENTS OF THE INVENTION

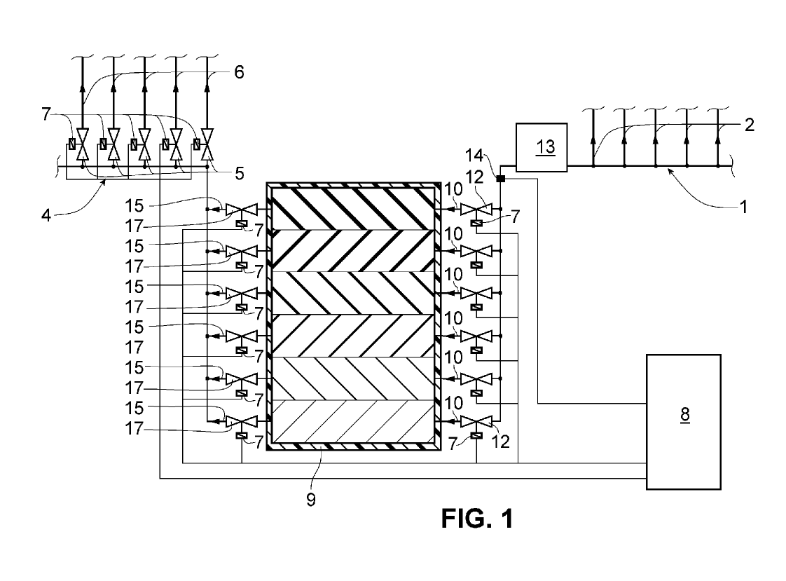

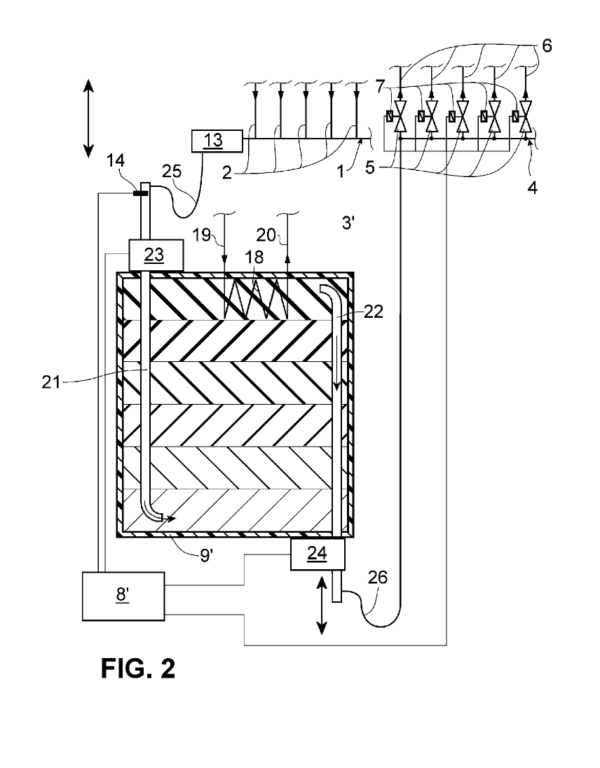

The storage tanks 3, 3′ to be seen in FIGS. 1 and 2 are intended to be installed in a production installation in which thermal energy is supplied by way of fluids, in particular process water and steam lines, during the production process. Such a production installation is in particular a paper mill. In a paper mill the process vats operate with heated process water. The water is heated by a supply of energy, for example by low-pressure steam coming from a power station. In addition radiators for drying the paper are heated by way of steam of that kind. Drying hoods and drying rollers are raised to an elevated temperature. Finally lubricating oil is heated. The manufacturing factory shops in cold regions are also heated to a predetermined temperature by way of radiators, by means of heated fluids.

Consequently in such a production installation a large number of fluid flows, in particular water flows at different temperatures, are to be passed to different heat consumers of the production installation. In addition fluid flows occur, which must be passed away from the production installations at different temperatures. The storage tank according to the invention serves for recovery, in an energetically most efficient fashion, of the energy of the waste water flows and the steam flows, for heating fluid flows which are to be supplied.

In FIGS. 1 and 2 the same components are denoted by the same references. References 1 denote a collecting line for service water which flows through various feed lines 2 to the storage tank 3 and 3′ respectively. The waste water comes from the various process stations and heat consumers by way of the feed lines 2 and it flows in the direction of the storage tank 3. Reference 4 denotes a discharge line with which water taken from the storage tank 3, 3′ is passed to various consumers. The discharge line 4 is connected by way of shut-off valves 5 to various fluid lines 6 leading to the different consumers. The shut-off valves 5 each have an actuating means 7 which can be moved into various switching positions by a control command from a control device 8, 8′. Preferably the actuating means 7 receive digital control commands from the control device 8. It is however also possible to provide hydraulic signal transmission, radio signal transmission or control signal transmission in any other fashion.

Depending on the respective demand for water, one or more of the actuating means 7 switches the fluid flow to one or more fluid lines 6. If parallel fluid flows have to be afforded it is also possible to provide a plurality of discharge lines 4.

The storage tank 3 and 3′ respectively is enclosed by a heat-insulating wall 9, 9′. Water is disposed in the storage tank 3 and 3′, in a stable temperature layering configuration. The various temperature layers are indicated by different hatchings. The coldest water is in the lower region of the storage tanks 3, 3′. That water is of the greatest density. The temperature of the water increases upwardly, with the density falling. The water in the uppermost region of the storage tank 3, 3′ can reach temperatures near the boiling point (100° C.). If an increased pressure is maintained in the boiler the maximum water temperatures can be even higher.

The water which flows into the storage tank 3, 3′ is fed to the respective temperature layer within the storage tank 3, 3′, the temperature of which corresponds to the temperature of the feed flow of water. To achieve that, two different embodiments of the storage tank 3 and 3′ are proposed.

The embodiment of the storage tank shown in FIG. 1 has six different feeds 10 arranged at different heights of the storage tank 3. Shut-off valves 12 make it possible to pass the fluid flow coming from the collecting line 1 into the storage tank 3 by way of a given one of the feeds 10, by means of the control device 8. Arranged in the collecting line 1 is on the one hand an ultrafiltration unit 13 which cleans the feed flow of water. On the other hand, arranged downstream of the ultrafiltration unit 13 is a temperature sensor 14 which is connected to the control device 8 by way of a signal line. If the temperature sensor 14 detects a low temperature in the feed flow of water the upper five shut-off valves 12 are shut off so that a flow of water into the five upper feeds 10 is blocked. The water flows to the lowermost shut-off valve 12 which permits an inflow of water. Consequently cold water flows into the cold liquid region near the bottom of the storage tank 3.

If a higher temperature is measured with the temperature sensor 14 one of the shut-off valves 12 which are disposed at a higher level passes the fluid flow into a feed 10 at a higher level so that the water flows into a fluid layer at a higher level within the storage tank 3.

In a corresponding fashion water is taken from the storage tank 3 in dependence on the temperature required. In the present case the storage tank 3 also has six discharges 15 which can be connected to the discharge line 4 by way of controlled shut-off valves 17. Control of the shut-off valves 17 is effected by means of actuating means 7.

The discharge line 4 is connected by way of shut-off valves 5 to fluid lines 6 which, depending on the respective process station or consumer involved, to which the fluid line 6 leads, require water at different temperatures. In this case also there are provided actuating means 7 which can be actuated by way of the control device 8 and which connect a discharge 15 at a given height to the discharge line 4 to feed water at the corresponding temperature. If a plurality of fluid flows at different temperatures are to be discharged at the same time a plurality of discharge lines 4 can be connected to the storage tank by way of discharges 15.

Temperature sensors (not shown) can be arranged in the storage tank 3 at different heights, to measure the temperatures at their respective hight levels. A respective temperature sensor can be appropriately provided at the height level of a feed 10 or discharge 15. Then the feed or discharge is selected for the feed or discharge of process water, at the height of which the temperature of the water within the storage tank corresponds to the predetermined temperature in the line.

FIG. 2 shows an alternative embodiment of the storage tank 3′. In this case the storage tank 3′ has only one feed 21 and discharge 22. The feed 21 is in the form of an inlet pipe which can be raised and lowered by way of a drive motor 23. In the same way the discharge 22 is in the form of an outlet pipe which can be raised and lowered by way of a drive motor 24. The two drive motors 23 and 24 are actuated by way of the control device 8′ so that, depending on the respectively required or prevailing water temperature, they adjust the inlet pipe 21 or the outlet pipe 22 to the corresponding height within the storage tank 3′.

The collecting line 1 and the discharge line 4 are connected by way of a flexible line portion 25, 26, in particular a hose, to the inlet pipe 21 and outlet pipe 22 respectively to compensate for the displacement in height.

It is possible to provide a plurality of inlet pipes 21 and outlet pipes 22 in the FIG. 2 embodiment so that it is possible to implement at the same time a plurality of fluid removal operations or fluid feed operations, at various temperatures.

Finally FIG. 2 shows a heat exchanger 18 through which flows steam which is supplied and discharged with steam lines 19, 20. The heat exchanger 18 takes the remaining thermal energy from the steam and stores it within the water in the water tank.

It will be appreciated that it is also possible for a heat exchanger to be arranged upstream of one of the feed lines 2, to heat the water flowing through the feed line. It is also possible for the heat exchanger to be in the form of a condenser for the feed flow of steam, which provides for condensing the water and thereby heats service water simultaneously. That heated service water can be fed to the storage tank 3′ by way of one of the feed lines 2.

### LIST OF REFERENCES

1 collecting line
2 feed line
3 storage tank
4 discharge line
5 shut-off valve
6 fluid line
7 actuating means
8 control device
9 insulated wall
10 feed
12 shut-off valve
13 ultrafiltration unit
14 temperature sensor
15 discharge
17 shut-off valve
18 heat exchanger
19 steam line
20 steam line
21 feed, inlet pipe
22 discharge, outlet pipe
23 drive motor
24 drive motor
25 flexible line portion, hose
26 flexible line portion, hose

1. A storage tank for the storage of a fluid heated in relation to the ambient temperature, comprising:
a heat-insulated wall;
a plurality of discharges; and
a plurality of feeds, wherein the feeds are arranged at different height levels of the storage tank, and wherein the discharges are arranged at different height levels of the storage tank; and
a control device which passes a fluid flow at a higher temperature through a discharge or a feed at a higher height level and passes a fluid flow at a lower temperature through a discharge or a feed at a lower height level.

2. A storage tank for the storage of a fluid heated in relation to the ambient temperature, comprising:
a heat-insulated wall;
at least one discharge;
at least one feed, wherein the feed is displaceable to different height levels of the storage tank, and wherein the discharge is displaceable to different height levels of the storage tank; and
a control device which passes a fluid flow at a higher temperature to the discharge or the feed that is at a higher height level and passes a fluid flow at a lower temperature to the discharge or the feed that is at a lower height level.

3. The storage tank according to claim 2, further comprising:
at least one temperature sensor for measuring the temperature of a flowing fluid, wherein the control device establishes the height level of the discharge or feeder in dependence on the measured temperature value.

4. The storage tank according to claim 2, wherein the control device feeds a hot fluid flow to the primary side of a heat exchanger and feeds a colder fluid flow to the secondary side of the heat exchanger and feeds the fluid flow flowing from the secondary side to the storage tank.

5. The storage tank according to claim 2, wherein the control device feeds a heated steam flow to a condenser which heats a colder fluid flow which is fed to the storage tank by the control device.

6. The storage tank according to claim 2, wherein the control device takes a hot fluid flow from the storage tank from the discharge at the higher height level and feeds the hot fluid flow to the primary side of a heat exchanger, and wherein the control device feeds the fluid flow flowing from the primary side to the feed at the lower height level.

7. The storage tank according to claim 2, wherein at least one of the following is provided: (i) the at least one discharge is arranged in an upper region of the storage tank, and (ii) the at least one feed is arranged in a lower region of the storage tank.

8. (canceled)

9. The storage tank according to claim 2, wherein the storage tank has a volume of at least 1000 m³.

10. The storage tank according to claim 2, further comprising:
at least one heat exchanger is arranged in an interior of the storage tank.

11. The storage tank according to claim 10, wherein the heat exchanger is displaceable in height.

12. The storage tank according to claim 2, further comprising:
a filter, arranged upstream of the feed, through which the feed flow of fluid passes.

13. The storage tank according to claim 12, wherein the filter is an ultrafiltration unit.

14. (canceled)

15. The storage tank according to claim 1, further comprising:
at least one temperature sensor for measuring the temperature of a flowing fluid, wherein the control device establishes the height level of at least one of the discharges or feeders in dependence on the measured temperature value.

16. The storage tank according to claim 1, wherein the control device feeds a hot fluid flow to the primary side of a heat exchanger and feeds a colder fluid flow to the secondary side of the heat exchanger and feeds the fluid flow flowing from the secondary side to the storage tank.

17. The storage tank according to claim 1, wherein the control device feeds a heated steam flow to a condenser which heats a colder fluid flow which is fed to the storage tank by the control device.

18. The storage tank according to claim 1, wherein the control device takes a hot fluid flow from the storage tank from the discharge at the higher height level and feeds the hot fluid flow to the primary side of a heat exchanger, and wherein the control device feeds the fluid flow flowing from the primary side to the feed at the lower height level.

19. The storage tank according to claim 1, wherein at least one of the following is provided: (i) at least one of the discharges is arranged in an upper region of the storage tank and (ii) at least one of the feeds is arranged in a lower region of the storage tank.

20. The storage tank according to claim 1, wherein the storage tank has a volume of at least 1000 m³.

21. The storage tank according to claim 1, further comprising:
at least one heat exchanger is arranged in an interior of the storage tank.

22. The storage tank according to claim 21, wherein the heat exchanger is displaceable in height.

23. The storage tank according to claim 1, further comprising:
a filter, arranged upstream of the feed, through which the feed flow of fluid passes.

24. The storage tank according to claim 23, wherein the filter is an ultrafiltration unit.

25. A production installation, comprising:
a process station which uses at least one fluid at a given temperature; and
a storage tank, the storage tank including:
a heat-insulated wall;
at least one discharge;
at least one feed; and
a control device which passes a fluid flow at a higher temperature to the discharge or the feed at a higher height level and passes a fluid flow at a lower temperature to the discharge or the feed at a lower height level,
wherein at least one of the following is provided:
(i) fluid of the fluid flow is taken from the storage tank at a given height level by the control device in dependence on the given temperature by way of the discharge and fed to the process station;
(ii) the fluid flowing away from the process station after use is fed to the feed at a given height level by the control device at the given temperature; and
(iii) the fluid for the process station is heated by way of a heat exchanger supplied with hot fluid from the storage tank.

26. The production installation according to claim 25, wherein the at least one discharge includes a plurality of discharges, and wherein the at least one feed includes a plurality of feeds, and wherein the control device passes the fluid flow at the higher temperature through a discharge or a feed at a higher height level and passes a fluid flow at a lower temperature through a discharge or a feed at a lower height level.

27. The production installation according to claim 25, wherein the at least one feed is displaceable to different height levels of the storage tank, and wherein the at least one discharge is displaceable to different height levels of the storage tank.

28. The production installation according to claim 25, wherein the process station is one of a plurality of process stations in the production installation.
